(19) United States
(12) Patent Application Publication
(10) Pub. No.: US 2005/0185413 A1
(43) Pub. Date: Aug. 25, 2005

(54) Variable multisource lighting device

(76) Inventors: Jan Martoch, Hranice (CZ); Milan Cejnek, Novy Jicin (CZ); Vladimir Kubena, Novy Jicin (CZ); Leonard S. Livschitz, San Ramon, CA (US); Jeffrey Allen Erion, Plymouth, MI (US)

Correspondence Address: VISTEON, C/O BRINKS HOFER GILSON & LIONE, PO BOX 10395, CHICAGO, IL, 60610, US

(21) Appl. No.: 10/950,038

(22) Filed: Sep. 24, 2004

(30) Foreign Application Priority Data
Sep. 25, 2003 (CZ) PV 2003-2589

(51) Int. Cl. B60Q 1/00

(52) U.S. Cl. 362/487

(57) ABSTRACT

A variable multi-source lighting device is provided on both sides of the front part of a motor vehicle to illuminate both sides and/or only one side of the vehicle when driving in a curve. Activation may be determined by the steering wheel or a GPS signal. In use, the device forms a composite light beam composed of partial light beams from individual light sources. Some of the partial light beams are obliquely oriented relative to the vehicle's longitudinal axis and at least one partial light beam is generally parallel to the longitudinal axis. Depending on the vehicle's speed and/or the position of the steering wheel, the sources may be activated individually, in groups, progressively, discretely or continuously so as to increase or decrease the lateral dispersion of light.

### BACKGROUND

1. Field of the Invention

The present invention relates to a variable, multi-source lighting device. In particular, the invention relates to compact lighting units with a variable lighting capability for motor vehicles and intended for illumination of the area in front of and on the sides of the motor vehicle.

2. Related Technology

At the present time, variable-type headlamps for motor vehicles utilize mechanical rotation of the headlamp so that a horizontal displacement of the whole light beam is achieved. This manner of displacement of horizontal light beam is used, for example, in driving into curves and requires an exact mechanical adjustment of the whole headlamp. As a result, the manufacture of such systems is difficult and the production costs are high.

### SUMMARY

The variable, multi-source lighting device of the present invention works as an auxiliary light for low beam or high beam light modes of the vehicle and substantially improves the light distribution.

As applied to a motor vehicle, a lighting device is positioned on both sides of the front part of the vehicle and includes a series of individual light sources. Each of the light sources defines a partial light beam and the partial light beams cooperatively define a composite light beam that is emitted from the device. At least one of the partial light beams emanating from the device is directed along an axis that is generally parallel to the longitudinal axis of the vehicle. At least two other partial light beams are progressively oriented, in relation to the longitudinal axis of the motor vehicle, at increasing angular orientations laterally outward.

In an implemented system, the device is coupled to a controller (such as an electronic control system in the vehicle) that actuates (turns “on”, turns “off” or varies the intensity) the individual light sources depending on the status of the vehicle. The controller may simultaneously actuate the devices on both sides of the vehicle in conjunction with the front lights of the vehicle. Additionally, the controller may only actuate the device on one side of the vehicle when the vehicle is turning along a curved vehicle path. As an input to determine how to actuate the devices, the controller may be coupled to steering wheel angle sensor or to a global position satellite (GPS) device, which may be part of a navigation system in the vehicle.

In operation, the means for actuating the light sources may operate such that number of light sources turned “on” is variable depending on an increasing angle of rotation of the steering wheel. For example, with an increased steering wheel angle of rotation (indicating a sharper turning of the vehicle), a greater number of the light sources may be turned on providing a more dispersed light beam to the side of the vehicle or to the inside of the curved path of the vehicle. Alternately, the means for actuating the light sources may operate such that number of sources turned on is variable depending on the instantaneous speed of the motor vehicle. For example, with decreasing speed, a greater number of the light sources may be turned on providing a more dispersed light beam to the side of the vehicle or to the inside of a curved path of the vehicle. In either scenario, the controller may actuate the light sources progressively, based on the angular orientation of the partial light beam of the particular light source. Thus, the light sources may be separately actuated or actuated in groups.

The device itself may be collectively defined by a definitive or discrete number of separate lighting devices. However, in a preferred embodiment the device is unitary in construction and includes a plurality of chambers that are defined by reflectors and located in each one is one of the light sources. The light sources themselves may be of any know variety including incandescent bulbs, halogen bulbs, xenon bulbs, light emitting diodes (LED), etc. With either construction, the envelope of the device(s) may be in the shape of a circle, an ellipse, a rectangle or a square.

In turning “on” or “off” the light sources, the device may activate the light sources in a discrete or continuous fashion.

One of the light sources of the device may operate as and according to the conditions for activation of a fog headlight.

### BRIEF DESCRIPTION OF THE DRAWINGS

The preferred, but not limiting, embodiment of the present invention is described below with reference to the accompanying drawings, in which:

FIG. 1 is a front view of a unit of variable multisource lighting device according to the present inventon; and

FIG. 2 is a view in horizontal cross-section showing an optical layout of the variable multitsource lighting device of FIG. 1.

### DETAILED DESCRIPTION

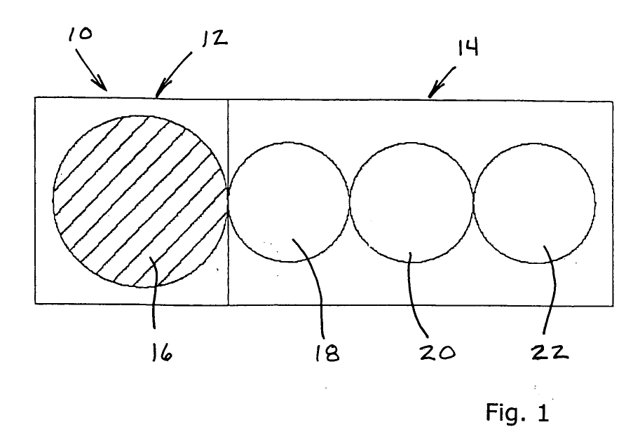

Referring now to the drawings, seen in FIG. 1 is a variable lighting device 10 embodying the principles of the present invention and provided as a four chamber system. The variable lighting device 10 includes a base segment 12 and a side segment 14 which are intended to respectively illuminate the front and side areas of the motor vehicle.

The segments 12, 14 each include chambers 16, 18, 20, 22, with the base segment 12 having a single chamber 16 and the side segments 14 having three chambers 18, 20, 22. Each chamber 16, 18, 20, 22 has its own light source 24, 26, 28, 30 and is characterized by its own partial light beam, which is different for each chamber 16, 18, 20, 22. The resulting light spot of the device 10 is thus composed of a series of partial light beams from the individual chambers 16, 18, 20, 22 and modification of this light spot is made by activation or deactivation of the individual chambers 16, 18, 20, 22 of the whole device 10. The chambers 16, 18, 20, 22 themselves are defined by reflectors 32, 34, 36, 38 which are constructed in accordance with well known techniques in the industry. As such, the reflectors 32, 34, 36, 38 each include a reflective surface that operates to reflect light generated by the light source 24, 26, 28, 30 in a direction generally parallel to the optical axis 40, 42, 44, 46 thereof.

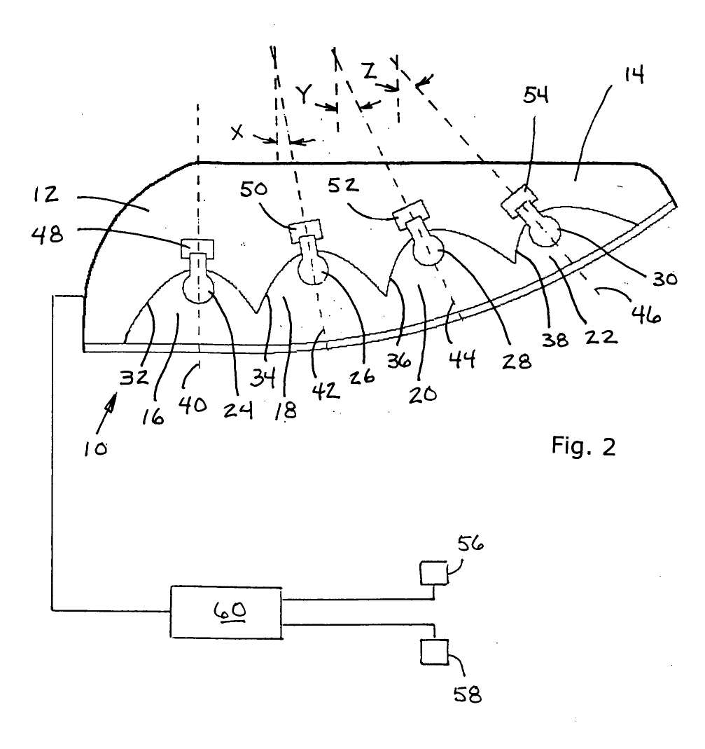

The optical axis 40 of the base segment 12 is generally parallel with the longitudinal axis of the motor vehicle. The optical axes 42, 44, 46 of the side segment 14, however, are obliquely oriented with respect to the longitudinal axis of the motor vehicle. Proceeding away from the chamber 16 of the base segment 12, it is seen that the angle defined by each successive chamber 18, 20, 22 increases with respect the longitudinal axis of the vehicle. As a result, each successive chamber 18, 20, 22 provides additional light to the side of the motor vehicle. As seen in FIG. 2, the angles defined by the optical axes 42, 44, 46 with respect to the longitudinal axis of the vehicle are respectively identified as angles X, Y and Z. The light sources 24, 26, 28, 30 may be individual bulbs or arrays now known or hereafter derived. As such, the bulbs may be incandescent bulbs, halogen bulbs, xenon bulbs, light emitting diodes or other light sources. Each light source 24, 26, 28, 30 is received and fitted in its respective reflector 32, 34, 36, 38 by means of a socket 48, 50, 52, 54 or other mounting structure. The sockets 48, 50, 52, 54 are electrically connected to an electrical power source (not shown) such as a battery, alternator or other device provided in the motor vehicle.

A basic beam is formed by the base segment 12. This basic beam is generally characterized by a light intensity distribution of a front fog headlight. As such, the basic beam created by the light source 24 and chamber 16 of the base segment 12 preferably conforms with Regulation #19 Uniform Provisions Concerning the Approval Of Motor Vehicle Front Fog Lamps Of The United Nations Agreement Concerning The Adoption Of Uniform Technical Prescriptions For Wheeled Vehicles, Equipment And Parts Which Can Be Fitted And/Or Be Used On Wheeled Vehicles And The Conditions For Reciprocal Recognition Of Approvals Granted On The Basis Of These Prescriptions. While illustrated as having a single chamber 16, the base segment 12 could alternately include one or more chambers whose partial light beams create the resulting light beam of the whole base segment 12.

The side segment 14 is intended to illuminate the side of the motor vehicle, either the left or the right side of the motor vehicle depending upon the orientation and positioning of the variable lighting device 10. In the optical axes 42, 44, 46 of the chamber 18, 20, 22 are progressively oriented with respect to the longitudinal axis of the vehicle, the lateral dispersion of a light beam created by the side segment 12 can be increased or decreased or altered by successively activating or deactivating the chambers 18, 20, 22. Activations of these chambers during operation of the side segment 14 can be done either progressively, (first chamber 18, then chamber 20 and finally chamber 22) or through activation of various groupings of the chambers (for example, chambers 18 and 22 being activated together without activation of chamber 20 or chambers 20 and 22 being activated together without chamber 18 or any of the chambers 18, 20, 22 being activated individually without the remaining chambers).

The switching on of the individual light sources 24, 26, 28, 30 in the respective chamber 16, 18, 20, 22 may be either discrete or continuous. In the latter, the voltage provided to the light source 40, 42, 44, 46 would be gradually increased so that lighting intensity of the light source 40, 42, 44, 46 is gradually increased according to a desired start up or turn on characteristic.

The variable lighting device 10 is believed to have applicability in at least three modes of operation, including a fog mode, a low beam contribution mode and an adaptive front lighting system, AFS, contribution mode. Each of these modes is further discussed below.

In the fog mode of operation, the variable lighting device 10 is used in conjunction with either the low beam or high beam, and possibly the parking lights, provided by the primary headlamps of the vehicle. In this mode of operation, a variable lighting device 10 provided on the right and left front part of the motor vehicles are both used. More specifically, the base segment 12 is utilized in this mode and is activated in compliance with the conditions required for activation of the front fog lamps of the vehicle (for example, only operating in combination with the headlamps of the vehicle when low beam light is being produced).

In a low beam light contribution mode of operation, the variable lighting device 10 is used in conjunction with the headlamps of the vehicle as those headlamps are producing low beam light. The variable lighting device 10 is utilized such that when the motor vehicle is driving into a right hand curve, the variable lighting device 10 increases the lateral dispersion of light to the right side of the low beam light produced by the headlamps of the vehicle. More specifically, the variable lighting device 10 located on the right side of the front of the motor vehicle will activate one or more of the chambers 18, 20 and 22 of the variable lighting device 10. Similarly, when driving into a left hand curve, the variable lighting device 10 on the left side of the front of the vehicle is activated to increase the lateral dispersion of the low beam light. Activation of the side segment 14 may be determined by a sensor 56 sensing rotation of the steering wheel of the motor vehicle or by a global position satellite (GPS) signal 58 via the motor vehicle's navigation system or other system. Either of these signal may be communicated to an electronic controller 60 which appropriately and accordingly activates the light sources 24, 26, 28, 30.

In an AFS contribution mode of operation, the activation of individual chamber 16, 18, 20, 22 are controlled and dependent upon the speed of the motor vehicle. For example, at low speed operation of the vehicle, the lateral dispersion of light to both the left and right side of the vehicle may be maximized so that the front and side areas of the vehicle are illuminated. At higher speeds, the lateral dispersion may be decreased, minimized or not used at all. Additionally, variations to the lateral dispersion of light can be made when the motor vehicle is in a passing mode of operation or other modes of operation.

1. A variable multi-source lighting device positioned on both sides of a front part of a motor vehicle comprising a plurality of individual light sources, each of said individual light sources defining a partial light beam and said partial light beams cooperatively defining a composite light beam from said device, at least one of said partial light beams being generally parallel to the longitudinal axis of the motor vehicle, at least two of said partial light beams being progressively oriented in relation to the longitudinal axis of the motor vehicle at increasing angular orientations thereto, means for actuating said individual light sources on both sides of the motor vehicle with front lights of the motor vehicle and on only one side of the motor vehicle when the motor vehicle is turning along a curved vehicle path.

2. The device of claim 1 wherein said means for actuating said individual light sources includes steering wheel angle of rotation sensor.

3. The device of claim 1 wherein said means for actuating said individual light sources includes a global position satellite (GPS) device.

4. The device of claim 1 wherein said means for actuating said individual light sources is variable depending on the instantaneous speed of the motor vehicle such that with decreasing speed a greater number of said individual light sources are activated.

5. The device of claim 1 wherein said means for actuating said individual light sources is variable such that with an increasing angle of rotation of the steering wheel a greater number of said individual light sources are activated.

6. The device of claim 5 wherein said means for actuating said individual light sources progressively activates said individual light sources based upon said angular orientation of said partial light beam of said individual light sources.

7. The device according to claim 1 wherein said device includes a plurality of chambers in which are located one said individual light sources

8. The device according to claim 1 wherein said device collectively includes a definitive number of separate devices.

9. The device according to claim 1 wherein means for actuating said individual light sources activates said individual light sources individually.

10. The device according to claim 1 wherein said means for actuating said individual light sources activates said individual light sources in groups.

11. The device according to claim 1 wherein said individual light sources are halogen bulbs.

12. The device according to claim 1 wherein said individual light sources are xenon bulbs.

13. The device according to claim 1 wherein said individual light sources are light emitting diodes.

14. The device according to claim 1 wherein said means for actuating said individual light sources activates said individual light sources in a discrete fashion.

15. The device according to claim 1 wherein said means for actuating said individual light sources activates said individual light sources in a continuous fashion.

16. The device according to claim 15 wherein said means for activating said individual light source includes an electronic controller.

17. The device according to claim 1 wherein said means for activating said individual light sources defaults to the conditions for activation of a fog headlight.

18. The device according to claim 1 wherein an envelope of said device has a shape of a circle, an ellipse, a rectangle or a square.

19. A variable multi-source lighting device located on the front end of the motor vehicle, said lighting device comprising a plurality of adjacent chambers, each of said chambers being defined by a reflector and having light source located therein, one of said chambers defining a first optical axis, remaining one of said chambers defining optical axes obliquely oriented with respect to said first optical axis, at least two of said remaining ones of said optical axes being obliquely oriented with regard to said first optical axis at different angles from one another.
